(19) United States
(12) Patent Application Publication
(10) Pub. No.: US 2006/0248821 A1
(43) Pub. Date: Nov. 9, 2006

(54) Milcore jamb strip

(76) Inventor: Michael Fitzpatrick, Murrieta, CA (US)

Correspondence Address: STETINA BRUNDA GARRED & BRUCKER, 75 ENTERPRISE, SUITE 250, ALISO VIEJO, CA, 92656, US

(21) Appl. No.: 11/418,882

(22) Filed: May 5, 2006

Related U.S. Application Data
(60) Provisional application No. 60/679,344, filed on May 9, 2005.

(51) Int. Cl. E06B 1/04

(52) U.S. Cl. 52/204.1; 52/211

(57) ABSTRACT

An apparatus for installing a corner bead to a doorway is provided. The apparatus may comprise a flange and an attachment base which are integrally connected to each other. The attachment base is securable to a doorframe such that upon securement, the flange and the doorframe form a receiving channel for receiving the corner bead therein. Such configuration maintains the structural integrity of the doorframe, maintains the length of the exposed edge of the doorframe and reduces cost to install the corner bead to the doorway.

### CROSS-REFERENCE TO RELATED APPLICATIONS

This Application claims the benefits of U.S. Provisional Patent Application No. 60/679,344, filed May 9, 2005, the entire contents of which are expressly incorporated herein.

### STATEMENT RE: FEDERALLY SPONSORED RESEARCH/DEVELOPMENT

Not Applicable

### BACKGROUND

The present invention relates to a method of installing a corner bead to a doorway, and also to an apparatus for installing the corner bead to the doorway.

Conventionally, a drywall corner bead is installed on a doorway by manually sawing a slot in a latch side jamb and a hinge side jamb of a doorframe for receiving the drywall corner bead. As will be further explained below, such conventional method of installing the drywall corner bead is unsatisfactory.

A door is installed in a wall by framing an opening in the wall such that the opening is sized and configured to fit a doorframe. The doorframe may be comprised of a latch side jamb, a hinge side jamb and a top jamb connected to upper distal ends of the latch and hinge side jambs. Before the doorframe is disposed within the opening of the wall, a slot may be manually sawed into edges of the jamb, as shown in FIG. 1. After the slot is sawed into the jambs, the doorway is disposed within the opening of the wall. Shims may be disposed between the doorframe and an adjacent trimmer stud. The shims are adjusted until the doorframe is squared. Thereafter, the shims are nailed to the jambs and the trimmer studs. At this point, the jamb may fail due to the thin or reduced thickness of the jamb. In particular, when the slots were sawed into the edges of the jamb, it created stress concentrations or weak points at a base of the slot. As such when the nail is hammered into the doorframe, the weak point of the base of the slot may be fractured thereby damaging the doorframe. Also, the prior art method of attaching the corner bead to the doorway increases cost to manufacture or install the corner bead because the slot must be manually sawed in the factory or at the construction site. Another deficiency of the conventional method of installing the corner bead to the doorway is that an exposed edge of the jamb is reduced because the slot must be sawed at about a middle portion of the jamb edge, which increases the cost of radius millwork.

To mitigate against the reduction of the exposed edge of the jamb, prior art methods of installing the corner bead may include utilizing a jamb having a wider exposed edge such that when the slot is sawed into the jamb, the exposed edge of the jamb is approximately the same as typical jambs. Unfortunately, jambs having a wider exposed edge cost more due to the additional material, and further requires special oversized framing.

Accordingly, there is a need in the art for an improved method for installing a corner bead to a doorway and also for an apparatus for installing the corner bead to the doorway.

### BRIEF SUMMARY

The present invention addresses the needs discussed above, below and those that are known in the art. While various applications of embodiments of the present invention are discussed herein as being utilized on a doorframe, it is also contemplated that embodiments of the present invention may be used with any millwork that may accept a drywall corner bead, including doorframes, windows, and/or other finished flat and radius millwork. Therefore, it shall be understood that use of terms referring to doors or doorframes, such as the term “doorframe,” as well as the teachings herein, may be applied for other millwork, such as windows. Thus, embodiments of the present invention may be applied to other forms of millwork that accept a drywall corner bead, and should not be considered to be limited to doorframe applications.

According to an embodiment of the present invention, a jamb strip is attached to the doorframe which collectively forms a receiving channel to receive the drywall corner bead to make installation of the corner bead less costly on radius millwork and maintain the structural integrity of the doorframe. In particular, the doorframe may comprise a latch side jamb and a hinge side jamb and a top jamb. These jambs define lateral side surfaces and an upper surface. The jamb strip may be secured to the lateral side surfaces and the upper surface by stapling an attachment base of the jamb strip to such surfaces. A flange of the jamb strip may also be directed to the exterior of the wall. The flange of the jamb strip may define a receiving surface which may be offset from an interface surface of the attachment base. Accordingly, when the jamb strip is secured to the jamb, the receiving surface does not contact the lateral side surfaces of the latch and hinge side jambs and the upper surface of the top jamb. The receiving surface of the jamb strip flange and the lateral side surface/top surface of the jamb defines a receiving channel which receives the corner bead.

After the jamb strip is secured to the doorframe, the doorframe is disposed within an opening of the wall and squared via shims. The shims are secured to the doorframe and the wall via a nail, and the shims are cut off flush to the doorframe. The corner bead is then attached to a drywall of the wall and inserted into the receiving channel.

The corner bead may comprise a corner portion, a first flange and a second flange. The first flange may have a plurality of apertures for receiving a shaft of a nail. The first flange of the corner bead is laid adjacent to the drywall, and simultaneously, the second flange may be inserted into the receiving channel. Nails are inserted into the apertures of the first flange to secure the corner bead to the drywall. Correspondingly, the receiving channel secures the second flange of the corner bead to the door frame. The exterior surfaces of the doorframe, corner bead and the drywall are then painted to make the doorway aesthetically beautiful.

In a first embodiment of the jamb strip, the attachment base may define an upper surface having a convex configuration. The junction between the flange and the attachment base may have an abrupt change in direction which may serve as a guide for a staple gun or a nail gun. More particularly, when the installer secures the jamb strip to the doorframe, the installer may bump a staple gun against the guide to align the staple of the staple gun to a fulcrum of the upper surface. In this manner, the installer does not have to manually align the staple to the attachment base. Also, since the staple is aligned to the fulcrum of the upper surface, it is less likely that the staple will penetrate through the attachment base and into the doorframe. The installer may quickly staple the attachment base to the doorframe by bumping the staple gun against the guide along a plurality of points of the attachment base.

In an aspect of the jamb strip, the jamb strip may have a cam surface and a lip formed on a flange of the jamb strip. The cam surface, lip and receiving surface of the flange of the jamb strip along with the lateral side surface of the jamb forms a receiving channel for receiving a second flange of the corner bead. Also, the second flange of the corner bead may be formed with a pawl for engaging the lip for holding the corner bead to the jamb.

In another aspect of the jamb strip, the same may be reversible such that a first width of a receiving channel may be formed between a receiving surface of a first portion of the jamb strip and the lateral side surface of the jamb when the jamb strip is attached to the jamb in a first orientation (i.e., second portion attached to the jamb). Also, the jamb strip may form a second width of a receiving channel defined by a receiving surface of a second portion of the jamb strip and the lateral side surface of the jamb when the jamb strip is attached to the jamb in a second orientation (i.e., first portion attached to the jamb). Moreover, the first width may be narrower compared to the second width of the receiving channels for receiving corner beads having different second flange thicknesses.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of a prior art method of installing a drywall corner bead to a doorway;

FIG. 2 is a perspective view of a doorway;

FIG. 3 is an exploded cross-sectional view of the doorframe and wall illustrating a corner bead installable to the doorway via a jamb strip;

FIG. 4 is a perspective view of a corner bead defining a first flange and second flange with a corner portion interposed therebetween;

FIG. 5 is a first embodiment of the jamb strip;

FIG. 6 is a second embodiment of the jamb strip;

FIG. 7 is a third embodiment of the jamb strip;

FIG. 8 is a cross-sectional view of a doorframe incorporating a fourth embodiment of the jamb strip;

FIG. 8A is a partial exploded view of FIG. 8;

FIG. 9A is a fifth embodiment of the jamb strip;

FIG. 9B is an illustration of the fifth embodiment of the jamb strip attached to the doorframe in a first orientation;

FIG. 9C is an illustration of the fifth embodiment of the jamb strip attached to the doorframe in a second reversed orientation;

FIG. 10 is a partial view of an arched doorframe with the jamb strip secured to an upper surface of a top jamb;

FIG. 10A is a top view of the doorframe and jamb strip of FIG. 10;

FIG. 10B is a side view of the doorframe and jamb strip of FIG. 10; and

FIG. 11 is a flow chart of a method of installing the corner bead to the doorway with the jamb strip.

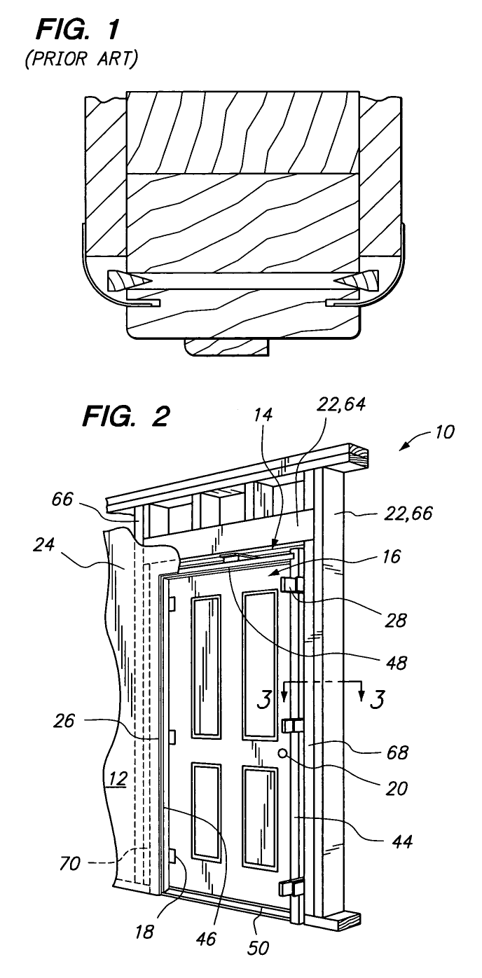

### DETAILED DESCRIPTION

Referring now to the drawings which are for the purpose of illustrating the preferred embodiments of the present invention and not for the purpose of limiting the same, FIG. 2 is a perspective view of a doorway 10. Although the various aspects of the present invention are described in relation to a doorway 10, the various aspects of the present invention may be variously embodied and employed in different situations. By way of example and not limitation, the various aspects of the present invention may be employed in windows, skylights, and the like. In particular, embodiments of the present invention may be used with any millwork that may accept a drywall corner bead 26, including doorframes, windows, and/or other finished flat and radius millwork. Therefore, it shall be understood that use of terms referring to doors or doorframes, such as the term “doorframe,” as well as the teachings herein, may be applied for other millwork, such as windows. Thus, embodiments of the present invention may be applied to other forms of millwork that accept the drywall corner bead 26, and should not be considered to be limited to doorframe applications.

The doorway 10 may comprise a wall 12 defining an opening. A doorframe 14 may be disposed within the opening and squared. Thereafter, a door 16 may be hung on the doorframe 14 which may be rotatable about hinges 18 and locked to the doorframe 14 via a latch 20.

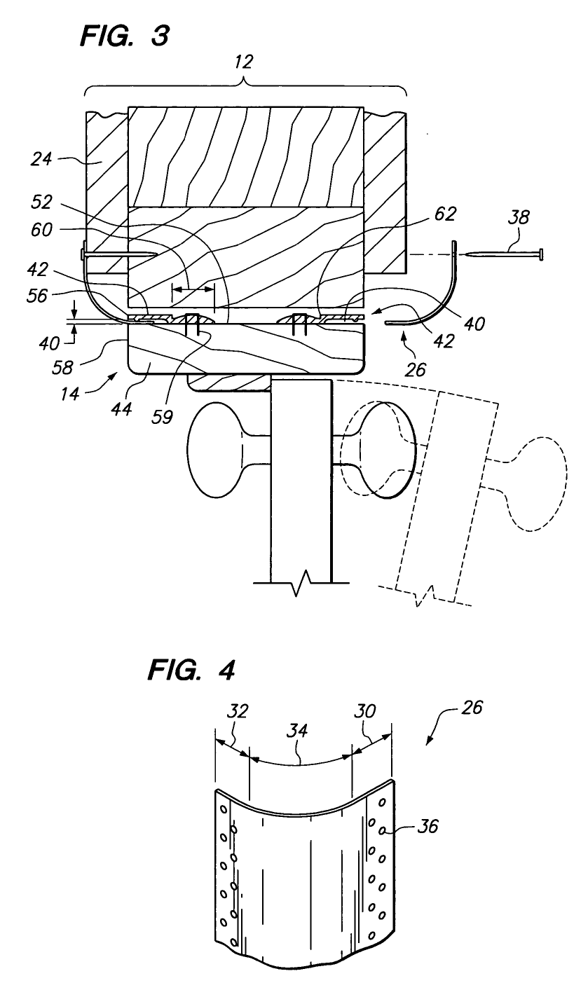

To make the doorway 10 more aesthetically beautiful, the wall 12 which may comprise a plurality of vertical and horizontal studs 22 may be overlaid or covered with drywall 24 and subsequently painted. Moreover, the drywall corner bead 26 may be attached to the wall 12 and the doorframe 14 which may hide (see FIG. 3) the shims 28, studs 22 and other raw construction materials (e.g., nails, staples, etc.) to make the doorway 10 more aesthetically beautiful.

As shown in FIG. 3, the corner bead 26 may be disposed adjacent to the drywall 24 and the doorframe 14. More particularly, the corner bead 26 may define a first flange 30 and a second flange 32 with a bead or corner portion 34 interposed therebetween (see FIG. 4). The bead or corner portion 34 shown in FIG. 3 has a rounded configuration, but it is also contemplated that the bead or corner portion 34 may have other configurations such as square (i.e., 90°), oblique, shaped and the like. The first flange 30 may be disposed against the drywall 24 (see FIG. 3). The first flange 30 may have a plurality of apertures 36 (see FIG. 4) for receiving a nail 38 so as to secure the first flange 30 and the corner bead 26 to the drywall 24. Nails 38 may proceed through the apertures 36 of the first flange 30 and into the drywall 24 and the stud underlying the drywall 24. In this manner, the corner bead 26 may be securely fixed to the building structure. The second flange 32 of the corner bead 26 may be received into a receiving channel 40 formed by a jamb strip 42 and the doorframe 14. As shown in FIG. 3, both sides of the wall 12 and doorframe 14 may be connected to each other via the corner bead 26. Although the structure shown in FIG. 3 is of a latch side jamb 44 of the doorframe 14, it is also contemplated that the corner bead 26 may be attached to the hinge side jamb 46, the top jamb 48 and/or a threshold 50. After the corner bead 26 is attached to the doorway 10, the exterior surfaces of the doorframe 14, corner bead 26 and drywall 24 may be painted to make the doorway 10 more aesthetically pleasing to visitors, guests and owners of the building structure.

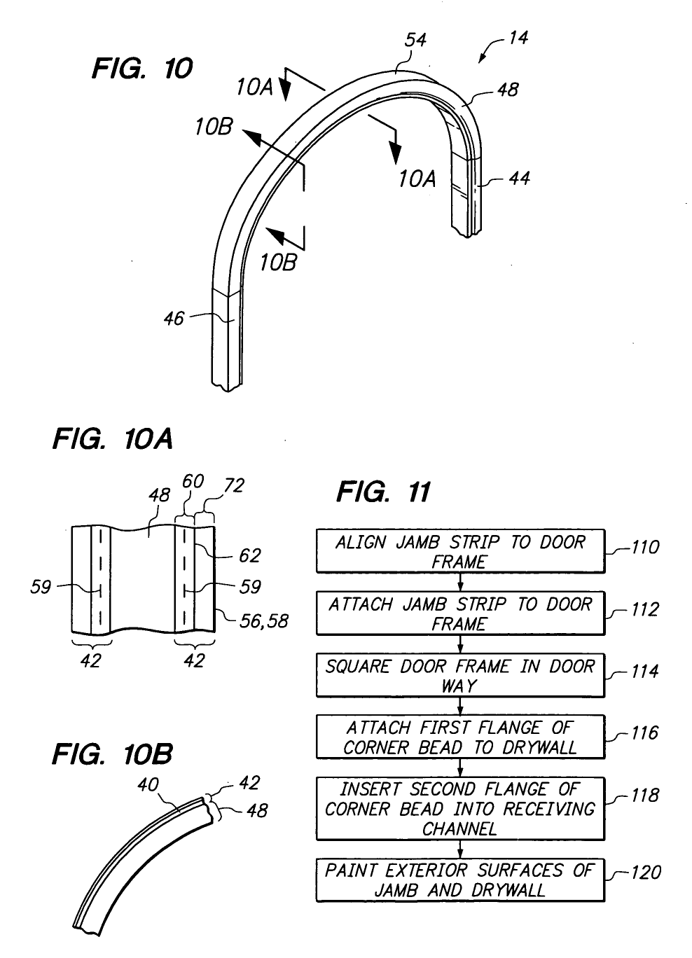

The jamb strip 42 may be attached to the doorframe 10 in the following manner. Initially, the doorframe 10 is not attached to or disposed in the opening of the wall 12. With the doorframe 14 not attached to the wall 12, the jamb strip 42 may be attached to lateral side surfaces 52 of the latch side jamb 44 and/or hinge side jamb 46, and/or the top surface 54 of the top jamb 48 (see FIG. 10). The jamb strip 42 may be a flexible strip such that it may bend and flex in its lengthwise direction. The flex permits the jamb strip 42 to hug the lateral side surfaces 52 of the side jambs 44, 46 when the jamb strip 42 is attached to the jamb 44, 46, 48 despite the shape of the lateral side surface 52 or top surface 54 of the jamb 44, 46, 48. By way of example and not limitation, if the top jamb 48 was arched, then the jamb strip 42 may conform to the curved arch configuration of the top jamb 48 (see FIG. 10). When the jamb strip 42 is disposed on the lateral side surface 52 or top surface 54 of the jamb 44, 46, 48, a flange 72 of the jamb strip 42 may be directed toward an exterior surface of the wall 12. A distal edge 56 (see FIG. 3) of the jamb strip 42 may be aligned with an exposed edge 58 of the jamb 44, 46, 48. The jamb strip 42 may be permanently attached to the jamb 44, 46, 48 via a staple 59 or nail 38. For example, the installer may staple an attachment base 60 of the jamb strip 42 to the jamb 44, 46, 48. Since the jamb strip 42 is attached to the door frame 14 as a long strip, the installer may staple the attachment base 60 at a plurality of points so as to securely attach the jamb strip 42 to the doorframe 14. In particular, the installer may bump a staple gun or nail gun against a guide 62 to align the staple or nail 38 to the attachment base 60.

Optionally, the jamb strip 42 may be interrupted such that the jamb strip 42 does not extend the entire length of the top jamb 48, the latch side jamb 44 or hinge side jamb 46. Rather, the jamb strip 42 may be interrupted to provide space such that shims 28 may be interposed between the doorframe 14 and the wall 12 to square the doorframe 14.

After the jamb strip 42 is attached to the doorframe 14, the installer disposes the doorframe 14 in the opening of the wall 12. The installer then inserts shims 28 between the doorframe 14 and the wall 12 to square the doorframe 14. In particular, the opening of the wall 12 may be defined by a header 64, king studs 66, a latch side trimmer stud 68 and a hinge side trimmer stud 70. With the doorframe 14 disposed within the opening of the wall 12, the installer may place a leveler against the latch side jamb 44 or the hinge side jamb 46. The installer inserts shims 28 between the latch side jamb 44 and the latch side trimmer stud 68, the hinge side jamb 46 and the hinge side trimmer stud 70, and the top jamb 48 and the header 64. The shims 28 are adjusted until the latch side jamb 44 or hinge side jamb 46 is level and the doorframe 14 is squared. A nail 38 is inserted through the doorframe 14, shims 28 and the trimmer stud 68, 70 to secure the shims 28 between the doorframe 14 and the trimmer stud 68, 70. After the shims 28 are secured via the nail 38, the protruding portions of the shims 28 are sawed off flush with the exposed edge of the doorframe 14.

The corner bead 26 which may comprise a first flange 30 and a second flange 32 interposed by a corner portion 34 (see FIG. 4) may be disposed about the outer periphery of the door 16. In particular, a first flange 30 may be disposed adjacent the drywall 24. The first flange 30 may have a plurality of apertures 36 through which a nail 38 may be inserted to secure the corner bead 26 to the wall 12 structure. In particular, as shown in FIG. 3, after the first flange 30 is disposed adjacent the drywall 24, a nail 38 may be inserted into the aperture 36 to secure the corner bead 26 to the wall structure. The second flange 32 may simultaneously be inserted into a receiving channel 40 formed by the jamb strip 42 and the latch side jamb 44. Thereafter, the doorframe 14, corner bead 26 and the drywall 24 may be painted to make the same more aesthetically pleasing.

The jamb strip 42 may be provided as a roll or as a long strip. The longitudinal length of the jamb strip 42 may be flexible such that the jamb strip 42 may conform to variously configured doorways 10 such as arched doorways. Additionally, the flexibility of the jamb strip 42 allows the jamb strip 42 to conform not only to a curvature of the doorway 10, but also may allow the jamb strip 42 to conform to a curvature of a window or a curvature of given millwork.

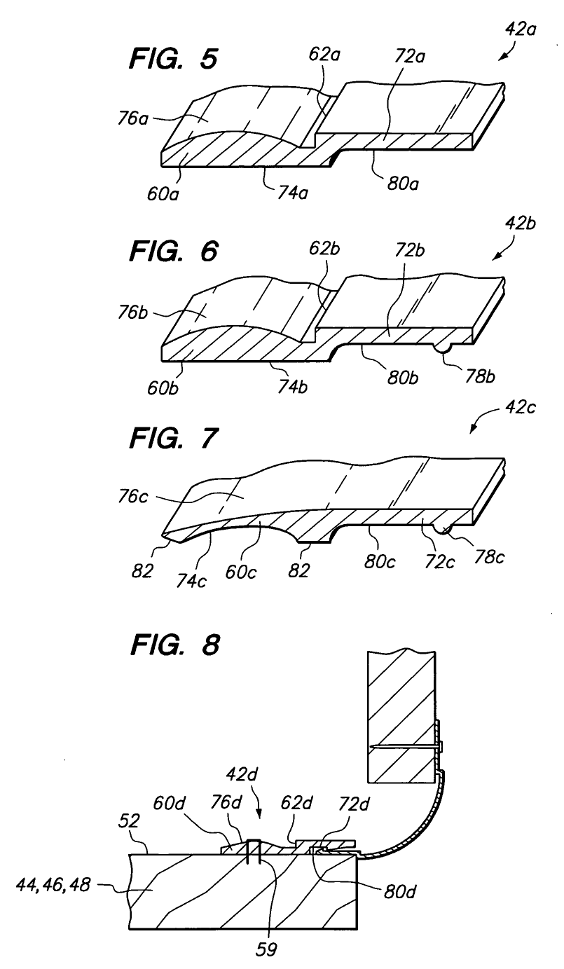

FIGS. 5-9C illustrate variously configured jamb strips 42. Although five embodiments of the jamb strip 42 are shown in FIGS. 5-9C, it is also contemplated that other configurations of the jamb strips 42 may be embodied and employed. As shown in FIG. 5, a first embodiment of the jamb strip 42a may have an attachment base 60a and a flange 72a. The attachment base 60a and the flange 72a may be fabricated from a unitary material. The attachment base 60a may define an interface surface 74a having a flat configuration. The interface surface 74a contacts the lateral side surface 52 of the side jambs 44, 46 or the top surface 54 of the top jamb 48 and aids in setting an offset distance between the flange 72a and the jamb 44, 46, 48, as discussed below. The attachment base 60a may also define an upper surface 76a. A thickness of the attachment base 60a defined by a distance between the upper surface 76a and the interface surface 74a may be sufficiently thick so as to prevent a staple or nail 38 being inserted through the attachment base 60a via a staple gun or nail gun to secure the jamb strip 42a to the doorframe 14 from penetrating through the attachment base 60a. By way of example and not limitation, the upper surface 76a may have a convex configuration wherein an attachment means (e.g., staple, nail, etc. and the like) may proceed therethrough and into the doorframe 14 to attach the jamb strip 42a to the doorframe 14. More particularly, a distance between a fulcrum of the upper surface 76a and the interface surface 74a may be sufficient to prevent the nail 38, staple 59 or other attachment means from penetrating through the attachment base 60a. The junction of the upper surface 76a and the flange 72a may have an abrupt change in direction. More particularly, the abrupt change in direction may be a vertical surface perpendicular to the interface surface 74a and/or a receiving surface 80a. The abrupt change in direction provides a guide 62a such that an installer may bump a staple gun or nail gun against the guide 62a such that the staple or nail 38 is aligned to the fulcrum of the upper surface 76a. In this manner, the installer may quickly staple a plurality of points along the attachment base 60a wherein the staples 59 are aligned to the fulcrum of the upper surface 76a by bumping the staple gun against the guide 62a. Moreover, a distance between the receiving surface 80a and the interface surface 74a may be greater than or equal to a thickness of the second flange 32 of the corner bead 26.

Referring now to FIG. 6, a second embodiment of the jamb strip 42b may also have an attachment base 60b and a flange 72b. The second embodiment of the jamb strip 42b may be identical with the first embodiment of the jamb strip 42a except that a nub 78b is formed on the receiving surface 80a of the flange 72b. Moreover, a distance between the nub 78b and the interface surface 74b may be less than or equal to a thickness of the second flange 32 of the corner bead 26. The jamb strip 42b may also define an upper surface 76b and a guide 62b similar to the upper surface 76a and guide 62a of the first embodiment of the jamb strip 42a.

Referring now to FIG. 7, a third embodiment of the jamb strip 42c may have an attachment base 60c and a flange 72c. The flange 72c may be identical with the flange 72b of the second embodiment of the jamb strip 42b (see FIG. 6). In particular, a nub 78c may be formed on a receiving surface 80c of the flange 72c. Alternatively, the flange 72c of the third embodiment of the jamb strip 42c may be formed in a similar fashion as the first embodiment of the jamb strip 42a (see FIG. 5). In particular, the receiving surface 80c does not incorporate a nub 78c. The attachment base 60c of the third embodiment of the jamb strip 42c may have an inclined upper surface 76c and a concave interface surface 74c. The attachment base 60 may also have two foots 82 for engaging the lateral side surface 52 of the side jamb 44, 46 or the top surface 54 of the top jamb 48. To install the jamb strip 42c on the jamb 44, 46, 48, the feet 82 of the attachment base 60c are laid on the lateral side surface 52 of the side jambs 44, 46 or the top surface 54 of the top jamb 48 with the flange 72c directed toward an exterior wall surface. A staple 59 or nail 38 is pierced through the attachment base 60c and into the jamb 44, 46, 48 to secure the jamb strip 42c to the jamb 44, 46, 48. More particularly, the nail 38 or staple 59 penetrates the upper surface 76 and may urge the concave interface surface 74c against the lateral side surface 52 of the jamb 44, 46, 48.

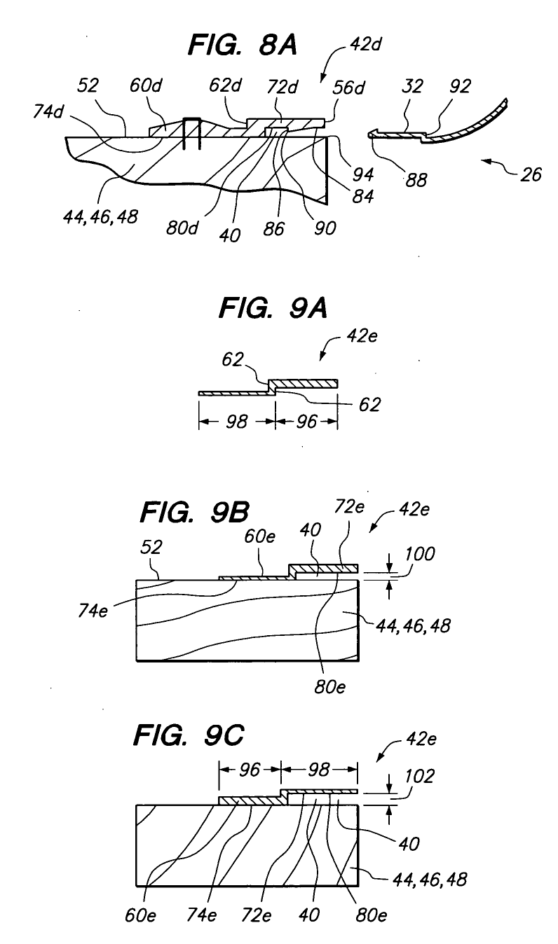

Referring now to FIGS. 8 and 8A, a fourth embodiment of the jamb strip 42d may have a similar configuration as that shown in the first embodiment of the jamb strip 42a (see FIG. 5). Moreover, the flange 72d may have a cam surface 84 which extends from a distal end 56d of the flange 72d to a medial portion thereof. A cam lip 86 may be formed at a terminal end of the cam surface 84. The flange 72d may also have a receiving surface 80d which together with the lip 86 and cam surface 84 and the lateral side surface 52 of the side jambs 44, 46 or top surface 54 of the top jamb 48 forms the receiving channel 40.

The receiving channel 40 may receive a second flange 32 of the corner bead 26. More particularly, the second flange 32 of the corner bead 26 may have a pawl 88 formed at a distal end thereof. A thickness of the pawl 88 may be equal to or less than a distance between the interface surface 74d of the attachment base 60d and the receiving surface 80d. Also, the distance or thickness of the pawl 88 may be greater than a distance between the lateral side surface 52 of the side jambs 44, 46 or top surface 54 of the top jamb 48 and the edge 90 of the lip 86. Moreover, a distance from the pawl 88 to an offset or an intersection 92 of the second flange 32 and the corner portion 34 of the corner bead 26 may be longer than or equal to a distance between the lip 86 and a distal edge 56d of the flange 72d. When the second flange 32 of the corner bead 26 is inserted into the receiving channel 40, the pawl 88 is interposed between the lateral side surface 52 of the jamb 44, 46 or top surface 54 of the top jamb 48 and the cam surface 84. The pawl 88 being thicker than a distance between the cam surface 84 and the lateral side surface 52 of the jamb 44, 46 or top surface 54 of the top jamb 48 deflects the flange 72d away from the jamb 44, 46, 48 until the pawl 88 passes the lip 86 of the flange 72. At about the same time, the offset junction 92 engages a corner 94 of the jamb 44, 46, 48. The second flange 32 of the corner bead 26 may not be removed from the receiving channel 40 because the pawl 88 engages the lip 86 (see FIG. 8). If required, the second flange 32 of the corner bead 26 may be removed from the receiving channel 40 by lifting the flange 72d away from the jamb 44, 46, 48 with a flathead screwdriver or the like.

FIGS. 9A-9C illustrates a reversible jamb strip 42e which is referred to herein as the fifth embodiment of the jamb strip 42e. The fifth embodiment of the jamb strip 42e may have a lightening bolt configuration. In particular, the jamb strip 42e may have a first portion 96 and a second portion 98 which are integrally formed as a unitary piece. As shown in FIG. 9A, the first portion 96 and the second portion 98 may be generally parallel but offset with respect to each other. The jamb strip 42e may be attached to the jamb 44, 46, 48, as shown in FIG. 9B or in a reversed orientation, as shown in FIG. 9C. In FIG. 9B, the second portion 98 of the jamb strip 42e functions as the attachment base 60e and the first portion 96 of the jamb strip 42e functions as the flange 72e. Accordingly, the first portion 96 and the lateral side surface 52 of the jamb 44, 46 or the top surface 54 of the top jamb 48 forms the receiving channel 40. A distance between the receiving surface 80e of the first portion 96 and the interface surface 74e of the second portion 98 defines a first width 100 of the receiving channel 40.

In FIG. 9C, the first portion 96 of the jamb strip 42e may function as the attachment base 60e and the second portion 98 of the jamb strip 42e may function as the flange 72e. Also, a distance between the receiving surface 80e of the second portion 98 of the jamb strip 42e and the interface surface 74e of the first portion 96 of the jamb strip 42e may define a second width 102 of the receiving channel 40 formed by the receiving surface 80e of the second portion 98 and the jamb 44, 46, 48. As shown by comparing FIGS. 9B and 9C, the first width 100 of the receiving channel 40 is narrower compared to the second width 102 of the receiving channel 40 (see FIG. 9C). Although the first and second portions 98, 98 of the fifth embodiment of the jamb strip 42 are shown as being generally flat, it is also contemplated that nubs 78, lips 86, cam surfaces 84 and curved upper surfaces 76 may be formed on the first and second portions 96, 98 in varying combinations.

The flange 72 may be attached to the attachment base 60, as shown in FIG. 5-9C. The flange 72 may define a receiving surface 80 which may be parallel with respect to the interface surface 74. Although the receiving surface 80 is shown and described as being flat and parallel with the interface surface 74, it is also contemplated that the receiving surface 80 may have other shapes and configurations such as concave, convex, skewed, etc. A distance between the receiving surface 80 and the interface surface 74 may be greater than or equal to a thickness of the second flange 32 of the corner bead 26. In this manner, the second flange 32 may be slid into and out of the receiving channel 40 formed by the jamb strip 42 and the doorframe 14 (1^{st}, 2^{nd}, 3^{rd} and 5^{th} embodiments of the jamb strip). The flange 72 of the jamb strip 42 may be fabricated from a material such that the flange 72 is urged back toward its natural configuration when the second flange 32 of the corner bead 26 pushes against the receiving surface 80. When the second flange 32 of the corner bead 26 is inserted into the receiving channel 40, there may be an imperfect fit therebetween. The imperfect fit causes the second flange 32 to push against the receiving surface 80 to thereby open the receiving channel 40 and push the flange 72 away from the jamb 44, 46, 48. Although the flange 72 is pushed away from the jamb 44, 46, 48, the resilient and flexible nature of the jamb strip 42 prevents the flange 72 from breaking off of the attachment base 60. Rather, the flange 72 pushes against the second flange 32 of the corner bead 26 to hold the corner bead 26 in place.

As shown in FIG. 3, when the attachment base 60 is secured to the jamb 44, 46, 48, the receiving surface 80 may be parallel with the lateral side surface 52 of the jamb 44, 46. To retain the second flange 32 in the receiving channel 40, a nub 78 (see FIGS. 6 and 7; second and third embodiments of the jamb strips 42b, 42c) may be formed on the receiving surface 80 which may urge the second flange 32 against the lateral side surface 52 of the jamb 44, 46. To this end, a distance between a distal end of the nub 78 and the interface surface 74 may be less than or equal to the thickness of the second flange 32 of the corner bead 26. Accordingly, when the second flange 32 is inserted into the receiving channel 40, the flange 72 may be deflected slightly away from the jamb 44, 46, 48 and the nub 78 urges the second flange 32 against the lateral side surface 52 of the jamb 44, 46, 48 to hold the corner bead 26.

By way of example and not limitation, the jamb 44, 46, 48 may have a width of about 1.5 in.; a width of the flange 72 may be about 0.563 in.; a throat of the receiving channel 40 may be about 0.4375 in.; and a gap of the receiving channel 40 may be about 0.094 in.

As stated above, the jamb strip 42 may be applied to a top jamb 48 having an arched configuration which is shown in FIGS. 10, 10A and 10B. Similar to the construction shown in FIGS. 2 and 3, the jamb strip 42 may be used to install a corner bead 26 to the arched doorway 10. FIG. 10 shows a curved top jamb 48 of an arched doorway 10. The jamb strip 42 may be attached to the hinge side jamb 46 and the latch side jamb 44 in the same manner discussed above. The jamb strip 42 may also be attached to the top or upper surface 54 of the curved top jamb 48. The jamb strip 42 may be attached to the entire outer periphery of the top jamb 48 because the jamb strip 42 is flexible in its longitudinal length. The jamb strip 42 may be secured to the top jamb 48 by stapling or nailing the attachment base 60 of the jamb strip 42 to the top jamb 48, as shown in FIG. 10A. Installation of the doorframe 14 and door 16 to the opening or doorway 10 may be made in a similar fashion as discussed above.

Referring now to FIG. 11, a flow chart of installing a jamb strip 42 to a doorframe 14 is as shown. In the method of installing the jamb strip 42 to the doorframe 14, a jamb strip 42 may be aligned to the doorframe 110. In particular, a distal edge 56 of the flange 72 may be flush with the exposed edge of the jamb 44, 46, 48. Thereafter, the jamb strip 42 may be attached to the doorframe 112. By way of example and not limitation, the jamb strip 42 may be stapled, nailed or the like to the jamb 44, 46, 48 via a staple gun or a nail gun. The staple or nail may be pierced through the attachment base 60 of the jamb strip 42 and into the jamb 44, 46, 48. After the jamb strip 42 is attached 112 to the doorframe 14, the doorframe 14 may be disposed within a doorway opening of a wall 12 and squared 114. With the doorframe 14 squared 114, a first flange 30 of a corner bead 26 may be attached 116 to a drywall 24 via a nail 38 or the like. Simultaneously or at about the same time, a second flange 32 of the corner bead 26 may be inserted 118 into a receiving channel 40 formed by the flange 72 of the jamb strip 42 and the lateral side surface 52 or top surface 54 of the jamb. At this point, the corner bead 26 is installed on the doorframe 14 and the exterior surfaces of the jamb 44, 46, 48 and drywall 24 may be painted 120.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A doorway comprising:
a) a wall having an opening for the doorway;
b) a door frame disposed in the wall opening;
c) a corner bead having a first flange disposed adjacent to the wall and a second flange disposed adjacent to the door frame; and
d) a jamb strip attached to lateral sides of the door frame forming a receiving channel for receiving the second flange of the corner bead.

2. The doorway of claim 1 wherein the wall comprises:
i. first and second king studs disposed on both sides of an opening of the doorway;
ii. first and second trimmer studs attached to the first and second king studs, respectively;
iii. a header attached to upper distal ends of the first and second trimmer studs; and
iv. drywall attached to the king studs, trimmer studs and header for covering the studs and header.

3. The doorway of claim 1 wherein the door frame comprises:
i. a latch side jamb and a hinge side jamb; and
ii. a top jamb connected to upper distal ends of the latch and hinge side jambs;
iii. wherein the door frame is shimed between the first and second trimmer studs and the header to square the doorway frame.

4. The doorway of claim 1 wherein the attachment base is sufficiently thick such that a staple of an automatic staple gun pierced through the attachment base and into the door frame does not penetrate through the attachment base.

5. The doorway of claim 4 wherein the attachment base defines an upper surface which has a convex configuration.

6. The doorway of claim 1 wherein the jamb strip is an elongate extruded part.

7. The doorway of claim 1 wherein the jamb strip is flexible for conforming to a curvature of the doorway.

8. A jamb strip for installing a corner bead to a door frame and drywall, the jamb strip comprising:
a) an attachment base for attaching the jamb strip to the door frame, the attachment base defining an interface surface;
b) a flange attached to the attachment base, the flange defining a receiving surface, the receiving surface being offset from the interface surface;
c) wherein the flange and the door frame form the receiving channel when the interface surface contacts the door frame and the attachment base is attached to the door frame.

9. The doorway of claim 8 wherein the flange is resilient.

10. The doorway of claim 8 wherein a distance of the offset is equal to or greater than a thickness of a second flange of the corner bead.

11. The doorway of claim 8 wherein the jamb strip further comprises a nub formed on the receiving surface of the jamb strip flange.

12. The doorway of claim 11 wherein a distance between a distal tip of the nub and the interface surface is equal to or less than a thickness of a second flange of the corner bead.

13. The doorway of claim 8 wherein the attachment base defines an upper surface which has a convex configuration.

14. The doorway of claim 8 wherein the jamb strip is an elongate extruded part.

15. The doorway of claim 8 wherein the jamb strip is flexible for conforming to a curvature of the doorway.

16. A method of installing a corner bead to a doorway, the doorway having a door frame and an opening defined by a trimmer stud which is covered by drywall, the method comprising the steps of:
a) aligning a jamb strip on a lateral side of the door frame;
b) aligning a flange of the jamb strip toward an exterior of the doorway;
c) attaching an attachment base of the jamb strip to the door frame for forming a receiving channel to receive a second flange of the corner bead;
d) disposing the door frame in the opening;
e) inserting the second flange of the corner bead into the receiving channel;
f) disposing a first flange of the corner bead against the drywall; and
g) attaching the first flange of the corner bead to the drywall.

17. The method of claim 16 wherein the attaching step c) comprises the step of stapling the attachment base to the door frame.
